(19) United States
(12) Patent Application Publication
(10) Pub. No.: US 2010/0194095 A1
(43) Pub. Date: Aug. 5, 2010

(54) Nutrition monitoring system

(76) Inventor: Michelle Tschaikowsky, Mettawa, IL (US)

Correspondence Address: Carmen Patti Law Group , LLC, ONE N. LASALLE STREET, 44TH FLOOR, CHICAGO, IL, 60602, US

(21) Appl. No.: 12/798,474

(22) Filed: Apr. 5, 2010

Related U.S. Application Data
(63) Continuation of application No. 11/827,949, filed on Jul. 13, 2007.

(51) Int. Cl. B42D 15/00

(52) U.S. Cl. 283/115

(57) ABSTRACT

An improved nutrition monitoring system includes a chart bearing first indicia identifying an individual, and second indicia relating to nutrition groups pertinent to the identified individual. The chart is adapted and constructed to receive marks. A marking mechanism is associated with the chart, the marking mechanism being adapted and constructed to make erasable and replaceable marks on the chart. A mounting mechanism mounts the chart on a surface adjacent to a food preparation and consumption area. The marking mechanism is used to make a mark on the chart in the area of the second indicia to tally consumption of an element of the respective nutrition groups by the identified individual.

### CROSS-REFERENCE TO RELATED APPLICATIONS

None

### STATEMENT AS TO RIGHTS TO INVENTIONS MADE UNDER FEDERALLY-SPONSORED RESEARCH AND DEVELOPMENT

None

### FIELD OF THE INVENTION

The present invention relates generally to monitoring and tracking systems, and specifically to systems for monitoring and tracking nutrition.

### DESCRIPTION OF RELATED ART

The concern for public awareness of proper nutrition has a long history in the United States. One of the pioneers in the field was Dr. W. O. Atwater of Weslyan University, the first Director of Research for the United States Department of Agriculture (USDA). As set forth by Susan Welsh of the USDA in the Journal of Nutrition, Vol. 124 No. 9_Suppl, September 1994, Dr. Atwater charted a new course for nutrition education 100 years ago by using the scientific process to develop dietary guidance to improve public health and well being. Each of the areas of research to which Atwater gave leadership—nutrient requirements, food composition, food consumption, and consumer economics—are essential components in the development of dietary guidance. The emerging science of nutrition was translated into recommendations for a healthful diet by Caroline Hunt in 1916 in the first USDA food guide. Other familiar food guides were the “Basic-7” developed in the 1940's and the “Basic-4” from the 1950's. These early guides focused primarily on getting enough nutrients. By 1970, research was providing evidence of the role of excessive intakes of certain food components in the etiology of chronic disease. With the release of the “Dietary Guidelines for Americans” in 1980, work began on a new food guide to address both concerns about nutritional adequacy and overconsumption. Research involved development of a new food guide and a graphic to illustrate it in 1992.

More recently, the USDA has refined and improved its dietary guidelines to customize the nutritional parameters according to age, weight, and levels of physical activity, as well as to include a wider variety of food groups. The guidelines are embodied in “My Food Pyramid”, which determines the amounts of grains, vegetables, fruits, milk, meats and beans, and oils to optimize nutritional health.

The USDA has various online methods for tracking and monitoring individual's adherence to the new Food Pyramid outlined at http://www.mypyramid.com. In general, nutrition intake monitors of various construction are known, and are well represented in the patent literature. One example is U.S. Pat. No. 5,691,927 to Gump, in which an instrument, preferably hand-held and hand-operated, assists in the determination of important nutritional information, such as the percentage of protein, fat and carbohydrates consumed during a given period of time, as well as the total calories consumed. The instrument may preferably operate in accordance with the principle of “food exchanges” and may also preferably include a capability for precise numerical entry of various nutritional quantities. In accordance with at least one preferred embodiment of the present invention, the instrument may be shaped in the manner of a “food pyramid” and contain sections reminiscent of the sections of a typical “food pyramid”.

In another example, U.S. Pat. Nos. 5,103,169 and 5,102,169, both to Mayfield, are directed to a daily medication management system including a chart listing medications, dosage times, and notes. Tactile and visual medication symbols and marking elements denote specific times for taking specific medications. Medication containers are similarly marked

U.S. Patent Publication No. US 2002/0055087 to Hardesty shows a calorie counter which would assist a user in managing the daily intake of protein, fat, carbohydrates, and calories. The present invention would have a protein intake button, a carbohydrate intake button, a fat intake button, and other buttons which would allow a user to keep track of the amount of each that he or she would have eaten in a particular day. A user would have to input the approximate level of carbohydrates, fats, and proteins eaten after each meal, and the present invention would tally these amounts and store them for the duration of a day. At the end of a day, a user could press a “clear” button, which would then erase the accumulated numbers in the memory of the present invention so it could start anew the next day.

Although these known monitoring systems provide some advantages, they present significant drawbacks as well. For example, many of the devices require relatively complicated data input, and are inconvenient to use and difficult to understand. It can be seen the foregoing that the need exists for a simple and inexpensive nutrition monitoring system that is inexpensive, effective, and easy to use.

### SUMMARY

In accordance with the principles of the present invention, an improved nutrition monitoring system includes a chart bearing first indicia identifying an individual, and second indicia relating to nutrition groups pertinent to the identified individual. The chart is adapted and constructed to receive marks. A marking mechanism is associated with the chart, the marking mechanism being adapted and constructed to make erasable and replaceable marks on the chart. A mounting mechanism mounts the chart on a surface adjacent to a food preparation and consumption area. The marking mechanism is used to make a mark on the chart in the area of the second indicia to tally consumption of an element of the respective nutrition groups by the identified individual.

The invention itself, however, both as to organization and method of operation, together with further objects and advantages thereof, may be best understood by reference to the following description taken in conjunction with the accompanying drawings.

### BRIEF DESCRIPTION OF THE DRAWINGS

FIG. 1 illustrates a nutrition monitoring system in accordance with the principles of the present invention.

FIG. 2 illustrates an alternative embodiment of a nutrition monitoring system in accordance with the principles of the present invention.

FIG. 3 illustrates another alternative embodiment of a nutrition monitoring system in accordance with the principles of the present invention.

FIG. 4 illustrates yet another alternative embodiment of a nutrition monitoring system in accordance with the principles of the present invention.

### DETAILED DESCRIPTION OF PREFERRED EMBODIMENTS

While this invention is susceptible of embodiment in many different forms, there is shown in the drawings, and will herein be described in detail, exemplary embodiments, with the understanding that the present disclosure is to be considered as illustrative of the principles of the invention and not intended to limit the invention to the exemplary embodiments shown and described.

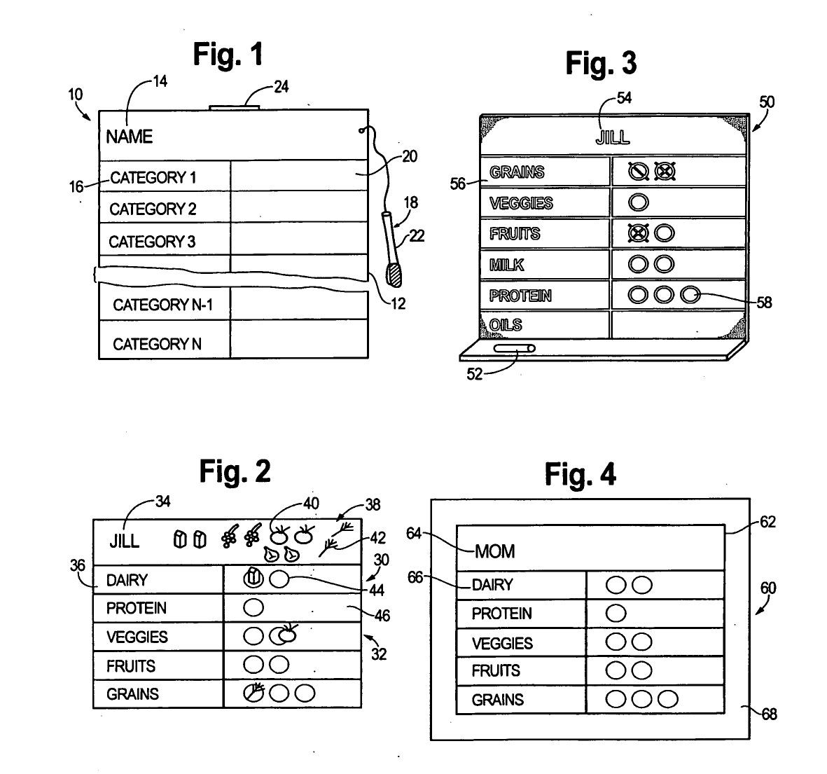

FIG. 1 illustrates a nutrition monitoring system 10 in accordance with the principles of the present invention. The system 10 includes a chart 12 bearing first indicia 14 identifying an individual who will be using the chart to monitor his or her nutritional intake. The indicia 14 can be provided in such a way as to be changeable or customizable, for example, by providing adhesive letters that can be applied to the chart 12, or by providing an area for a name that can be written in with a marker. Alternatively, the first indicia 14 can be permanently imprinted on the chart 12, for example, by screen printing.

The chart 12 is also provided with second indicia 16 relating to nutrition groups pertinent to the identified individual. The second indicia 16 can be provided as indicative of any nutrition groups pertinent to the identified individual. However, it is contemplated that it will be advantageous to provide indicia relating to FDA food groups, either in their the recent 5-group configuration, or the current 6-group form, including grains, vegetables, fruits, milk, meats and beans, and oils.

A marking mechanism 18 is associated with the chart 12. The marking mechanism 18 is adapted and constructed to make erasable and replaceable marks on the chart, thus facilitating long-term daily reuse of the system 10. The marking mechanism 18 is used to make a mark on the chart 12 in a tracking area 20 of the second indicia 16 to tally consumption of an element of the respective nutrition groups by the identified individual. In the example illustrated in FIG. 1, the marking mechanism is provided as a dry-erase marker 22 tethered to a dry-erase board on which the chart 12 is printed.

A mounting mechanism 24 is provided to mount the chart 12 on a surface adjacent to a food preparation and consumption area, such as the surface of a refrigerator or other kitchen appliance. In the embodiment illustrated in FIG. 1, the mounting mechanism 24 is shown as a hook-and-loop type of fastener having an adhesive backing.

As shown in FIG. 2, an alternative embodiment of a nutrition tracking system 30 includes a chart 32 bearing first indicia 34 and second indicia 36 similar to those shown in the previous embodiment. The system 30 is provided with a marking mechanism 38 in the form of a plurality of magnetic markers 40, 42 adapted to adhere magnetically to the chart 32, which is provided with magneto-compatible properties. The magnetic markers 40, 42 are provided as graphical elements corresponding to the food groups identified in the second indicia, and are used to cover placeholders 44 tracking areas 46 of the second indicia 36 to tally consumption of an element of the respective nutrition groups by the identified individual.

In FIG. 3, a chart 50 is provided as a chalkboard, with chalk 52 serving as a marking mechanism to tally nutritional intake. First indicia 54, second indicia 56, and placeholders 58 function as those shown in the previous embodiment.

In FIG. 4, the system 60 includes a chart 62 provided as a dry-erase board with a dry-erase marker 64 as a marking mechanism. First indicia 66, second indicia 68, and placeholders 70 function as those shown in the previous embodiment. The system 60 is provided with a frame 72, which may be configured as a magnetic frame for use in mounting the chart 62.

It can be seen from the foregoing that the present invention provides advantages in a wide range of applications. While details of the invention are discussed herein with reference to some specific examples to which the principles of the present invention can be applied, the applicability of the invention to other devices and equivalent components thereof will become readily apparent to those of skill in the art. Accordingly, it is intended that all such alternatives, modifications, permutations, and variations to the exemplary embodiments can be made without departing from the scope and spirit of the present invention.

What is claimed is:

1. An improved nutrition monitoring system comprising the following:
a chart bearing first indicia identifying an individual, and second indicia relating to nutrition groups pertinent to the identified individual, the chart being adapted and constructed to receive marks;
a marking mechanism associated with the chart, the marking mechanism being adapted and constructed to make erasable and replaceable marks on the chart; and
a mounting mechanism adapted and constructed to mount the chart on a surface adjacent to a food preparation and consumption area;
whereby the marking mechanism is used to make a mark on the chart in the area of the second indicia to tally consumption of an element of the respective nutrition groups by the identified individual.

2. An improved nutrition monitoring system in accordance with claim 1, wherein the second indicia relating to nutrition groups comprises indicia identifying FDA food groups.

3. An improved nutrition monitoring system in accordance with claim 2, wherein the second indicia relating to nutrition groups comprises indicia identifying food groups including grains, vegetables, fruits, milk, meats and beans, and oils.

4. An improved nutrition monitoring system in accordance with claim 1, wherein the chart comprises a dry-erase board, and the marking mechanism comprises a dry-erase marker.

5. An improved nutrition monitoring system in accordance with claim 1, wherein the chart comprises a chalk board, and the marking mechanism comprises a piece of chalk.

6. An improved nutrition monitoring system in accordance with claim 1, wherein the chart comprises a magnetic board, and the marking mechanism comprises a plurality of magnetic markers.

7. An improved nutrition monitoring system in accordance with claim 1, wherein the mounting mechanism comprises a mechanism for mounting the chart to an external surface of a refrigerator.

8. An improved nutrition monitoring system in accordance with claim 7, wherein the mounting mechanism comprises a magnetic frame.

9. An improved nutrition monitoring method comprising the following steps:
providing a chart bearing first indicia identifying an individual, and second indicia relating to nutrition groups pertinent to the identified individual, the chart being adapted and constructed to receive marks;
providing a marking mechanism associated with the chart, the marking mechanism being adapted and constructed to make erasable and replaceable marks on the chart;
mounting the chart on a surface adjacent to a food preparation and consumption area; and
using the marking mechanism to make a mark on the chart in the area of the second indicia to tally consumption of an element of the respective nutrition groups by the identified individual.

10. An improved nutrition monitoring method in accordance with claim 9, wherein the step of providing a chart bearing first indicia identifying an individual, and second indicia relating to nutrition groups pertinent to the identified individual comprises providing a chart bearing second indicia identifying FDA food groups.

11. An improved nutrition monitoring method in accordance with claim 9, wherein the step of providing a chart bearing first indicia identifying an individual, and second indicia relating to nutrition groups pertinent to the identified individual comprises providing a chart bearing second indicia identifying food groups including grains, vegetables, fruits, milk, meats and beans, and oils.

12. An improved nutrition monitoring method in accordance with claim 9, wherein the step of providing a chart comprises providing a dry-erase board, and the step of providing a marking mechanism comprises providing a dry-erase marker.

13. An improved nutrition monitoring method in accordance with claim 9, wherein the step of providing a chart comprises providing a chalk board, and the step of providing a marking mechanism comprises providing a piece of chalk.

14. An improved nutrition monitoring method in accordance with claim 9, wherein the step of providing chart comprises providing a magnetic board, and the step of providing a marking mechanism comprises providing a plurality of magnetic markers.

15. An improved nutrition monitoring method in accordance with claim 9, wherein the step of providing a mounting mechanism comprises providing a mechanism for mounting the chart to an external surface of a refrigerator.

16. An improved nutrition monitoring method in accordance with claim 15, wherein the step of providing a mounting mechanism comprises providing a magnetic frame.
